(19) United States
(12) Patent Application Publication
(10) Pub. No.: US 2005/0234756 A1
(43) Pub. Date: Oct. 20, 2005

(54) Management system for integrating multiple logistic bodies and method thereof

(75) Inventor: Claire Sun, Chung-Li City (TW)

Correspondence Address: WELSH & KATZ, LTD, 120 S RIVERSIDE PLAZA, 22ND FLOOR, CHICAGO, IL, 60606, US

(73) Assignee: Mitac International Corp., Hsinchu (TW)

(21) Appl. No.: 10/824,460

(22) Filed: Apr. 14, 2004

(51) Int. Cl. G06F 17/60

(52) U.S. Cl. 705/8

(57) ABSTRACT

A management system and method integrates account information and trade information of multiple logistic bodies on an enterprise data platform. The logistic bodies register their basic information in the system; the system receives trade information among the enterprise and the logistic bodies, analyzes the correlations among them and generates a common registration code to integrate and simplify the accounting management of the enterprise when working with the logistic bodies.

### BACKGROUND OF THE INVENTION

1. Field of the Invention

The invention generally relates to an information management system and method, and in particular relates to an information management system and method applicable to an enterprise data platform through which registration and trade information of multiple logistic agents are integrated and managed efficiently.

2. Related Art

A common enterprise, especially a manufacturer, usually assigns some distributors or logistic bodies for delivering materials and products. However, the enterprise, the logistic bodies and the deliveries are generally worldwide or countrywide that makes the trade relationships among the enterprise and the logistic bodies more complicate.

For example, when an enterprise “a” in a country A delivers goods via a logistic body L1 in the country A to an enterprise “b” in another country B, the logistic body L1 usually transfers the goods through some other logistic bodies L2, L3, L4, etc. under cost, path or facility considerations. As a result, the enterprise “a” is hard to manage the logistic bodies. Especially, the following problems may happen on the enterprise data platform:
1) The trade information related to the logistic body is unmanageable. Conventional data platform in an enterprise manages the logistic body individually. That is, each logistic body has a dependent identification for recoding the related trade information. Therefore, the practical trading process of aforesaid multiple body delivery cannot be timely managed on the enterprise data platform. The trade information among the multiple logistic bodies becomes blind spots of logistic process of the enterprise and influences the efficiency of electronic operations.
2) The accounting is rather complicated. Because the trade process among the enterprise and the logistic bodies are complicated and worldwide or countrywide, the accountings among them are not easy to handle. As the trading information among the relative logistic bodies is not well integrated, the performance of electronic process of the enterprise is degraded, and unnecessary expense may cause.

Therefore, how to integrate the logistic bodies, to manage trading and accounting on the data platform of the enterprise, and to solve the existing problems through simplified integration is the most important issue for improving the operation performance of enterprise data platform.

### SUMMARY OF INVENTION

The object of the invention is to provide a management system and method for integrating accounts of multiple logistic bodies. The invention uses the registration data and trade information of the logistic bodies registered on the enterprise data platform to analyze the correlations of accounts of the logistic bodies, then, integrates those correlative accounts into a common register code. Through the integration, the trade and account managements on the enterprise data platform are simplified and practical.

In an embodiment of the invention, the correlations of accounts are mainly based on the basic information provided by the logistic bodies during registration. In another embodiment, the correlations of accounts are mainly based on historical trade information among the logistic bodies and the enterprise. Through comparison and analysis with preset correlation rules, those correlative accounts of logistic bodies are registered with a common registration code. The electronic data platform conforms to the practical operation. The process is simplified and efficiently integrated.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is an operational block diagram of an integrated management system for multiple logistic bodies according to the invention;

FIG. 2 is a flowchart of integrating basic information of multiple logistic bodies in a management system and method of the invention; and

FIG. 3 is a flowchart of integrating trade information of multiple logistic bodies in a management system and method of the invention.

### DETAILED DESCRIPTION OF THE INVENTION

The invention provides a management system and method applicable to an enterprise data platform through which basic registration information and trade information of multiple logistic bodies related to the enterprise are integrated and managed.

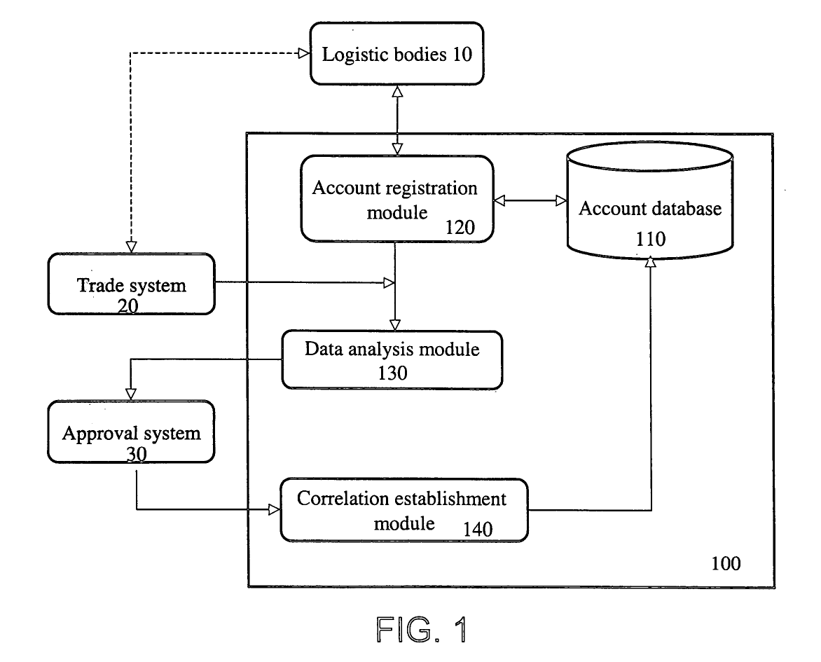

As shown in FIG. 1, a management system and method on the enterprise data platform for managing multiple logistic bodies 10 mainly includes an account integration system 100, a trade system 20 and an approval system 30. The account integration system 100 further includes the following portions.
1) an account database 110, for storing the account numbers and their registered basic information. Each account number also has at least one correlated account number and a common registration code shared with the correlated accounts for the management purpose.

In order to manage the logistic bodies 10 in the system, the account data base 110 of the system provides a registration procedure for each logistic body 10 to have an account number corresponding to the registered basic information of the logistic body 10 for future identification.

The common registration code is a code shared among an enterprise and its correlated logistic bodies. As to the common registration code, the trade information and accounting of at least two logistic bodies are processed as a sole object. The common registration code is established and based on preset correlation rules so that the complicated and practical correlations among the logistic bodies are registered. Therefore, the process of trade and accounting information on the enterprise data platform is simplified when the logistic bodies with the common registration code are handled as a whole.
2) An account registration module 120, for providing registration interface for the logistic bodies 10. Any a logistic body 10 can fill in her basic information, store it into the account database 110 and get an account number.

The basic information includes at least the name, e-mail address, website address and relative enterprises, etc. of the logistic body for judging the correlations. The items can also be user-modified in the user interface to meet the practical requirements.
3) A data analysis module 130, having preset correlation rules, for analyzing and comparing basic and trade information of the logistic bodies 10, and deciding the correlations among the account numbers.

The data analysis module 130 has two operation timings. The first is when a logistic body 10 being registered. The second is when the account integration system 100 being periodically receiving trade information from the trade system 20. The trade information is the trade record among the enterprise and the logistic bodies 10 and includes information of the assigned logistic body 10 and her sub-contracted logistic bodies 10. The correlation rules are logical algorithms of full-text comparison and calculation for the basic information or trade information of the logistic bodies.

When the account integration system 100 works with the approval system 30, and the data analysis module 130 finds a correlated logistic body 10 (through the account registration), the approval system 30 generates an approval event for starting an approval process.
4) A correlation establishment module 140, for integrating and establishing correlated account numbers and a common registration code according to the analysis result of the data analysis module 130. When the account integration system 100 works with the approval system 30, the correlation establishment module 140 operates according to the result (to establish a common registration code or not) of the approval event of the approval system 30.

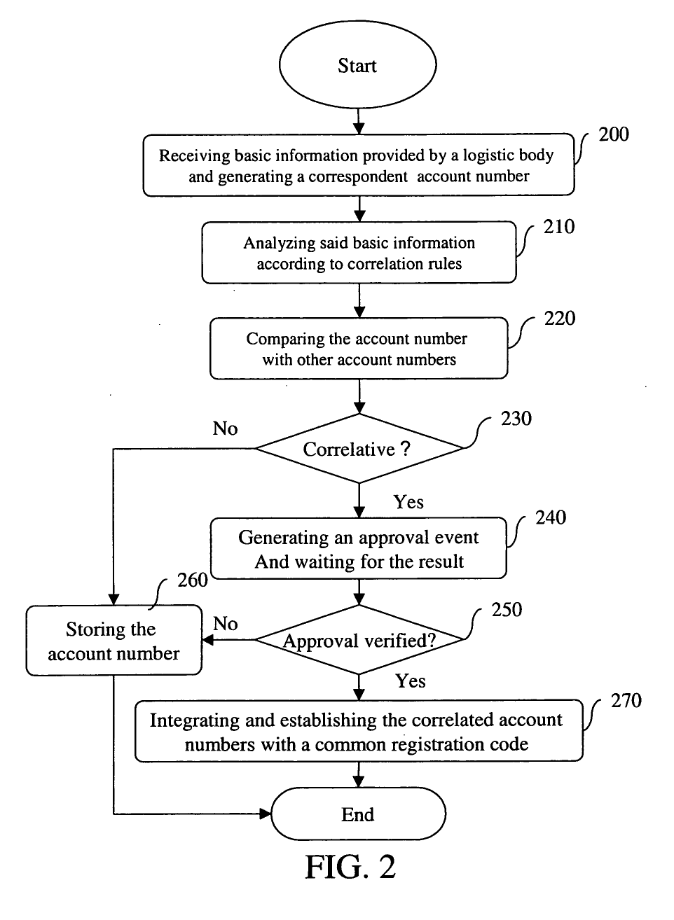

FIG. 2 is a flowchart of integrating basic information of multiple logistic bodies 10 in a management system and method of the invention during the registration procedure. It is a first embodiment of the account integration system 100 working with the approval system 30. First, the system receives a logistic body registering her basic information and provides an account number correspondent to the basic information (step 200). The registration is made via a user interface of the account integration system 100. The registered basic information includes at least the name of the logistic body, the email address, website address and name of relative enterprises. Then, analyzing the basic information according to preset correlation rules (step 210). The correlation rules include logical algorithms of real-time full-text comparison of the basic information and calculation of correlation ratio to other prior logic bodies. Further, comparing the account number with the other account numbers in the account database 110 (step 220); judging if the current logistic body 10 is high correlative to any other logistic body (step 230). If not correlative, directly registering the account number (step 260). Otherwise, there are correlations, producing an approval event and waiting for the result of the approval system 30 (step 240). If the approval event is not approved (step 250), the correlation is invalid, then registering the account number only (step 260). Otherwise, the approval event is approved (step 250), the correlation is verified, the account numbers of correlative logistic bodies 10 are then integrated and registered with a common registration code (step 270). After then, the relative information among these logistic bodies are identified by the common registration code and managed as a sole object.

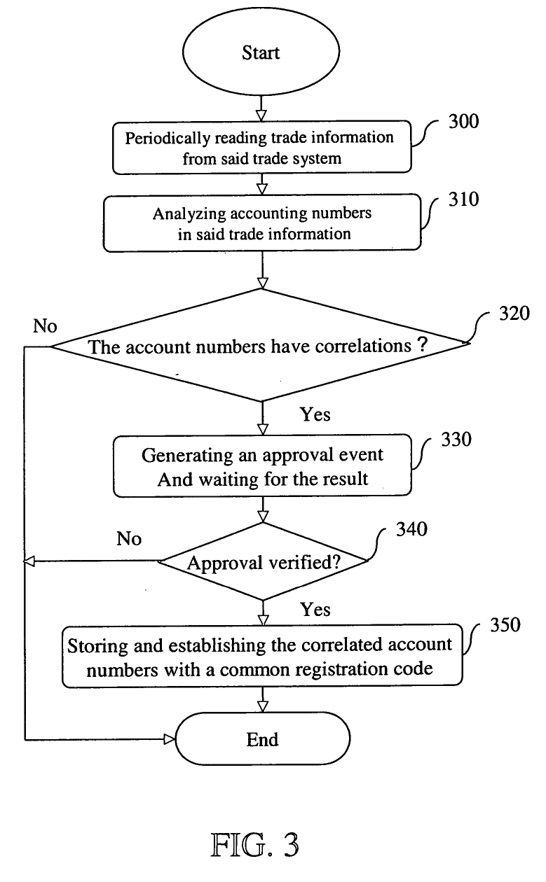

FIG. 3 is a flowchart of integrating trade information of multiple logistic bodies 10 in a management system and method of the invention through the trade system 20. It is a second embodiment of the account integration system 100 working with the trade system 20. First, the account integration system 100 periodically receives trade information from the trade system 20 (step 300). The trade information is the practical trade records among the enterprise and the logistic bodies 10. The trade information usually includes at least the name of the logistic body and the name of any sub-contracted logistic body. Then, analyzing the trade information and looking for correspondent account numbers in the account database 110 (step 310); checking if the logistic body 10 of the account number has information conformed to the correlation rules (step 320). If there are correlative information, producing an approval event and waiting for the result of the approval system 30 (step 330). If the approval event is approved (step 340), the correlation is verified; the account numbers of correlative logistic bodies 10 are then integrated and registered with a common registration code. If the approval event is not approved, no further action is taken.

In conclusion, the invention provides an integrated and simplified management system and method applicable on an enterprise data platform to manage the account registration and trade information among multiple logistic bodies. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A management system, applicable on an enterprise data platform, for managing multiple logistic bodies, comprising:
an account registration module, for providing registration interface for said logistic bodies to fill in basic information, and generating a correspondent account numbers;
a data analysis module, having preset correlation rules, for deciding correlations among said current account number and other account numbers;
a correlation establishment module, for integrating and establishing said correlated account numbers and common registration code according to analysis result of said data analysis module, and
an account database, for storing said account numbers and basic information, and storing for each account number at least one correlated account numbers and a common registration code shared with said correlated account numbers for management purpose.

2. The management system of claim 1 wherein said basic information comprises at least a logic body name, an email address, a website address and a relative enterprise name.

3. The management system of claim 1 further comprises an approval system, for receiving signal from said data analysis module upon correlations decided, and generating an approval event to start an approval process.

4. The management system of claim 1 further comprises a trade system, for periodically providing a plurality of trade information to said data analysis module for deciding correlations among a plurality of account numbers.

5. The management system of claim 1 wherein said correlation rules are logical algorithms of full-text comparison and calculation for basic information and trade information of said logistic bodies.

6. The management system of claim 1 wherein said correlation establishment module operates according to result of said approval event of said approval system.

7. A management method, applicable on an enterprise data platform incorporated with a trade system and an approval system, for managing multiple logistic bodies, comprising steps of:
receiving basic information provided by a logistic body and generating a correspondent account number;
analyzing said basic information according to correlation rules;
comparing a current account number with a plurality of other account numbers;
generating an approval event and waiting for result when said current account number and said plurality of other account numbers have correlations; and
integrating and establishing said correlated account numbers with a common registration code when said approval event is verified.

8. The management method of claim 7 wherein said basic information comprises at least a logic body name, an email address, a website address and a relative enterprise name.

9. The management method of claim 7 wherein said correlation rules are logical algorithms of full-text comparison and calculation for basic information and trade information of said logistic bodies.

10. The management method of claim 7 further comprises steps of:
periodically reading trade information from said trade system;
analyzing accounting numbers in said trade information;
generating an approval event and waiting for result when said account numbers have correlations; and
storing and establishing said correlated account numbers with a common registration code when said approval event is verified.

11. The management method of claim 10 wherein said correlation rules are logical algorithms of full-text comparison and calculation for trade information of said logistic bodies.
